(19) United States
(12) Patent Application Publication
(10) Pub. No.: US 2025/0300873 A1
(43) Pub. Date: Sep. 25, 2025

(54) REFERENCE SIGNAL FOR CHANNEL AND INTERFERENCE MEASUREMENT

(71) Applicant: ZTE Corporation, Shenzhen (CN)

(72) Inventors: Xingguang WEI, Shenzhen (CN); Xing LIU, Shenzhen (CN); Shuaihua KOU, Shenzhen (CN); Wei GOU, Shenzhen (CN); Xianghui HAN, Shenzhen (CN); Shuai FENG, Shenzhen (CN)

(73) Assignee: ZTE Corporation, Shenzhen (CN)

(21) Appl. No.: 19/230,514

(22) Filed: Jun. 6, 2025

Related U.S. Application Data
(63) Continuation of application No. PCT/CN2023/087118, filed on Apr. 7, 2023.

(51) Int. Cl. H04L 27/26; H04W 72/0446

(52) U.S. Cl. CPC H04L 27/2678; H04L 27/261; H04W 72/0446

(57) ABSTRACT

Methods of transmitting and receiving reference signal (RS) patterns are disclosed, wherein the RS pattern includes occupies two or more consecutive symbols, and wherein the RS pattern comprises a first cyclic prefix (CP), at least one RS signal, and a second CP.

### TECHNICAL FIELD

This disclosure generally relates to channel and interference measurement, and more specifically to a mechanism for transmitting Reference Signal (RS) patterns as part of channel and interference measurement.

### BACKGROUND

In the LTE and NR systems, OFDM (Orthogonal Frequency Division Multiplexing) is used. In various examples, CP (Cyclic Prefix) is used in the start of every OFDM symbol to combat the inter-symbol interference. Channel and CLI (Cross Link Interference) measurement is critical for cancelling or alleviating the interference between an aggressor wireless device (e.g., a base station or a User Equipment (UE)) and a victim (e.g., another base station or another User Equipment (UE)). The channel and CLI measurement between the aggressor and the victim relies on the timing alignment between the aggressor and the victim. If the timing difference between the aggressor and the victim exceeds the CP length, it is difficult or even impossible to obtain accurate measurement results.

As shown in the FIG. 3, to allow sufficient time for a base station to perform UL-to-DL switching, the UL symbol is usually shifted, e.g., 13 us ahead compared with the DL symbol at the base station side. In addition to the shifted 13 us, there are also some other factors that will impact the timing difference, e.g., the timing alignment accuracy between the DL slot of the aggressor and the DL slot of the victim, and transmission latency between the aggressor and the victim. However, compared with the 13 us shift, these other factors are much smaller and easier to be accommodated. In this case, the timing difference between the aggressor and the victim will obviously exceed the CP length at the victim side, which makes it difficult or even impossible to obtain accurate measurement results. Similar issues also exist for the UE-UE CLI measurement. There is a need to address the measurement accuracy in cases of large timing difference between aggressor and victim.

### SUMMARY

This disclosure generally relates to channel and interference measurement, and more specifically to new mechanisms for transmitting Reference Signal (RS) patterns as part of channel and interference measurement. The various example embodiments are particularly directed to providing for accurate channel and CLI measurement results between an aggressor wireless device and a victim wireless device by transmitting new RS patterns.

In some exemplary implementations, a method performed by wireless device (e.g., and aggressor wireless device and/or a victim wireless device) is disclosed. The method may include transmitting or receiving a Reference Signal (RS) pattern, wherein the RS pattern occupies two or more consecutive symbols, and wherein the RS pattern comprises, a first cyclic prefix (CP), at least one RS signal, and a second CP. In some exemplary implementations, which may be combined with any of the other exemplary implementations disclosed herein, the at least one RS signal is between the first CP and the second CP in the RS pattern. Also, a length of the RS signal in time domain is T_{RS}, a length of the first CP in the time domain is T_{CP1}, a length of the second CP in the time domain is T_{CP2}, and wherein a sum of T_{RS}, T_{CP1}, and T_{CP2} is equal to a length of the two or more consecutive symbols in the time domain.

In some exemplary implementations, which may be combined with any of the other exemplary implementations disclosed herein, the method also includes transmitting or receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal. In some examples, T_{RS} is equal to T_{CP2}, and/or the second CP signal is identical to one RS signal. In some examples, wherein the RS pattern occupies two consecutive symbols, T_{CP1} is equal to a sum of a length of a CP for a signal transmitted in a first symbol of the two consecutive symbols and a length of a CP for a signal transmitted in a second symbol of the two consecutive symbols, T_{RS} is equal to a length of the signal transmitted in the first symbol and is equal to a length of the signal transmitted in the second symbol.

In some exemplary implementations, which may be combined with any of the other exemplary implementations disclosed herein, the method also includes transmitting or receiving as part of the RS pattern, the at least one RS signal M times, wherein M is an integer and M is larger than 1. This may further include transmitting or receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal. In various examples, T_{CP1} may be equal to a length of a CP for a signal transmitted in the first symbol of the two or more consecutive symbols, T_{CP2} may be equal to a length of a CP for a signal transmitted in the second symbol of the two or more consecutive symbols, and M*T_{RS} may be equal to a sum of a length of the signal transmitted in the first symbol and a length of the signal transmitted in the second symbol. In examples, where M=2, T_{RS} is equal to the length of the signal transmitted in the first symbol and is equal to the length of the signal transmitted in the second symbol.

In some exemplary implementations, which may be combined with any of the other exemplary implementations disclosed herein, the RS pattern occupies N consecutive symbols, wherein N is an integer larger than 2. In various examples, the at least one RS signal is between the first CP and the second CP in the RS pattern. Also, a length of the RS signal in time domain is T_{RS}, a length of the first CP in the time domain is T_{CP1}, a length of the second CP in the time domain is T_{CP2}, and wherein a sum of T_{RS}, T_{CP1}, and T_{CP2} is equal to a length of the N consecutive symbols in the time domain.

In some exemplary implementations, which may be combined with any of the other exemplary implementations disclosed herein, the method also includes transmitting or receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal. In some examples, T_{RS} is equal to T_{CP2}, and/or the second CP signal is identical to one RS signal.

In some exemplary implementations, which may be combined with any of the other exemplary implementations disclosed herein, the method also includes transmitting or receiving, as part of the RS pattern, the at least one RS signal M times, wherein M is an integer and M is larger than 1. This may further include transmitting or receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal.

In some exemplary implementations, which may be combined with any of the other exemplary implementations disclosed herein, the method also includes transmitting or receiving the RS pattern in downlink (DL) symbols at least partially overlapping with gap symbols of either the wireless device or another wireless device. Further, the method may include transmitting or receiving only a first portion of the second CP. The method may also includes transmitting or receiving an indication of a location of the gap symbols, determining symbols that are at least partially overlapping with the gap symbols, and transmitting or receiving the RS pattern in the symbols that are at least partially overlapping with the gap symbols.

In some exemplary implementations, which may be combined with any of the other exemplary implementations disclosed herein, the method also includes mapping and/or transmitting or receiving the RS signal mapped to frequency resources every P resource elements (REs), wherein P is an integer larger than 0. The method may include transmitting or receiving no signal in REs between the every P REs. The method may also include configuring or receiving a configuration of an offset S to indicate different REs for different reference signals. The method may also include indicating or receiving an indication of a subcarrier spacing to receive the RS pattern. The method may also include determining a value of P based on subcarrier spacing, wherein a numerology of subcarrier spacing for the wireless device and another wireless device is u_{A} and u_{V}, respectively, wherein u_{V} is not smaller than u_{A}, and wherein P=2^{u}^{_{V}}^{-u}^{_{A}}. Alternatively, the method may also include determining a value of P based on subcarrier spacing of the wireless device and a reference subcarrier spacing, wherein a numerology of subcarrier spacing for the wireless device and the reference subcarrier spacing is u_{A} and u_{R}, respectively, wherein u_{V} is not smaller than u_{R}, and wherein P=2^{u}^{_{V}}^{-u}^{_{R}}.

In some other implementations, an apparatus for wireless communication such as a network device is disclosed. The network device main include one or more processors and one or more memories, wherein the one or more processors are configured to read computer code from the one or more memories to implement any one of the methods above. The apparatus for wireless communication may be the wireless access node or the wireless terminal device.

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with exemplary wireless communications in accordance with various embodiments.

FIG. 2 shows various example processing components of the wireless terminal device and the wireless access network node of FIG. 1.

FIG. 3 shows an example signal timing diagram in accordance with various embodiments.

FIG. 4 shows another example signal timing diagram in accordance with various embodiments.

FIG. 5 shows an example RS pattern in accordance with various embodiments.

FIG. 6 shows additional aspects of the example RS pattern in accordance with various embodiments.

FIG. 7 shows another example RS pattern in accordance with various embodiments.

FIG. 8 shows another example RS pattern in accordance with various embodiments.

FIG. 9 shows an example signal timing diagram in accordance with various embodiments.

FIG. 10 shows an example signal timing diagram in accordance with various embodiments.

FIG. 11 shows an example of frequency resource mapping in accordance with various embodiments.

### DETAILED DESCRIPTION

The technology and examples of implementations and/or embodiments described in this disclosure can be used to facilitate transmission of particular RS patterns for channel and interference measurement in wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

Disclosed herein are new mechanisms for transmitting particular RS patterns as part of channel and interference measurement procedures. The various example embodiments provide specific configurations and details of the RS pattern. Through the use of the disclosed embodiments, the accuracy of channel and CLI measurement results between an aggressor wireless device and a victim wireless device can be improved.

### Wireless Network Overview

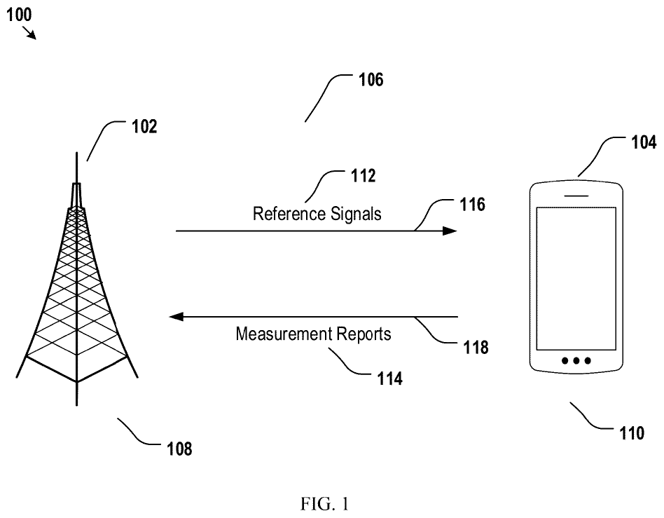

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

In various embodiments of the present disclosure, as depicted in FIG. 1, the base station 102 may be an “aggressor” wireless device 108 (also simply referred to as the aggressor), and the UE 104 may be a “victim” wireless device 110 (also simply referred to as the victim). However, the present disclosure is not limited to such an arrangement. For example, the aggressor wireless device 108 and the victim wireless device 110 may both be base stations 102, the aggressor wireless device 108 and the victim wireless device 110 may both be UEs 104, the aggressor wireless device 108 may be a base station 102 and the victim wireless 110 device may be a UE 104, or the aggressor wireless device 108 may be a UE 104 and the victim wireless device 110 may be a base station 102. Reference is made throughout this disclosure and the claims to the “aggressor wireless device” 108 and the “victim wireless device” 110, and it is understood that each of those terms may represent either a base station 102 or a UE 104 in accordance with the above example arrangements.

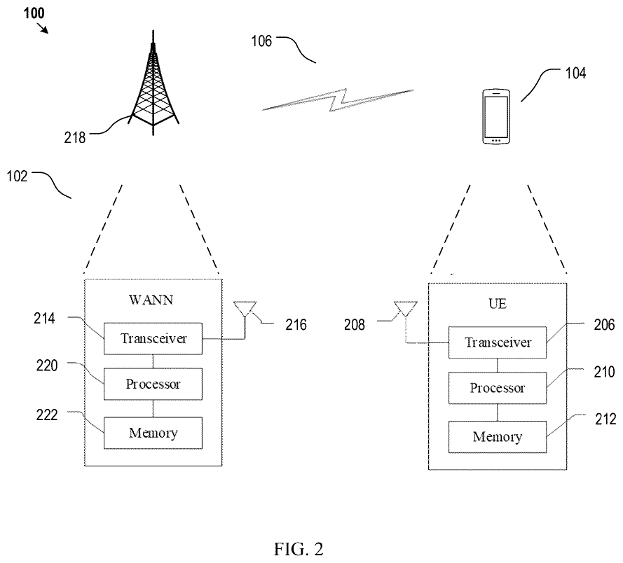

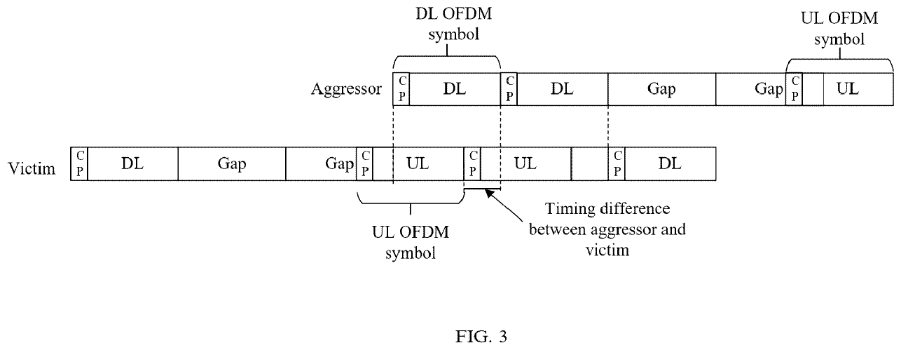

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes described herein. Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Reference Signals (RS)

In various embodiments, Reference Signals (RS) are signal that are used in the Downlink (DL) or Uplink (UL) channels for the purpose of measuring the characteristics of a radio channel so that the devices can adjust characteristics to optimize the channels (e.g., use correct modulation, code rate, beam forming etc.). For example, UEs 102 use the RS to measure the quality of the DL channel and send measurement reports in the UL channel, e.g., through Channel Quality Index (CQI) Reports.

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink (DL) channels 116 for transmitting wireless signals from the base station 102 to the user equipment 104 and physical uplink (UL) channels 118 for transmitting wireless signals from the user equipment 104 to the base station 102.

As part of communication from the aggressor wireless device 108 to the victim wireless device 110 (e.g., the DL channels 116), the aggressor wireless device 108 may transmit Reference Signals (RS) 112. Similarly, in response, as part of communication from the victim wireless device 110 to the aggressor wireless device 108 (e.g., the UL channels 118), the victim wireless device 110 may transmit measurement reports 114.

### Description of New Reference Signal Design

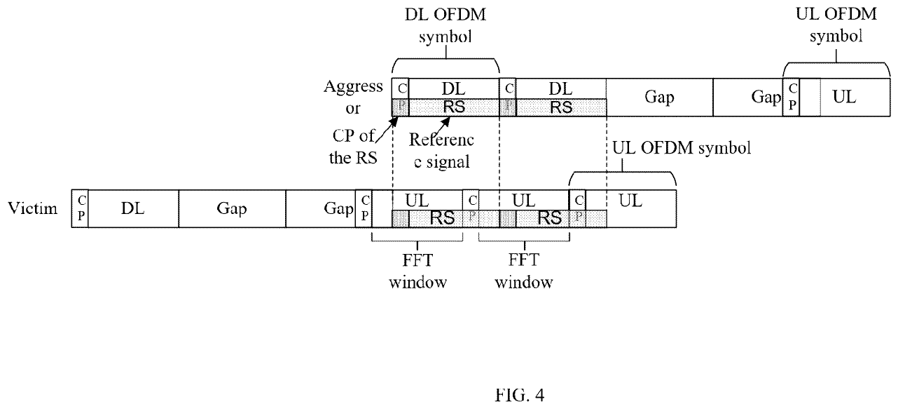

Referring to FIG. 4 as an example, in accordance with various embodiments, an Aggressor wireless device 108 may transmit RS, and the victim wireless device 110 needs to measure the RS. However, due to the timing difference between the aggressor wireless device 108 and the victim wireless device 110, part of the RS is outside the FFT (Fast Fourier Transform) window for each OFDM symbol. Specifically, in this example, an end part of the second RS signal is in a following UL symbol, and would not be measured within the correct FFT window. Therefore, the data in the second RS signal would not be included in the measurement in the correct FFT window. If the victim wireless device 110 applies the data obtained during the FFT window to measure the channel or interference, it can't obtain accurate measurement results as it is missing at least a portion of the RS signal.

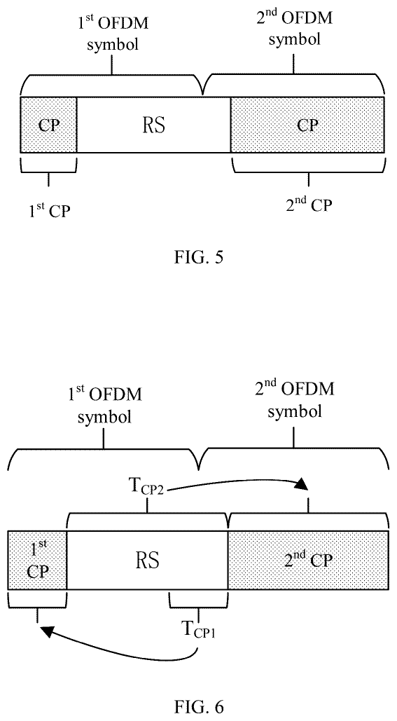

With reference now to FIG. 5, an example of a new RS pattern design is disclosed. In accordance with various embodiments, for one subcarrier spacing, one RS pattern occupies two consecutive OFDM symbols corresponding the subcarrier spacing. (Other embodiments discussed below provide for an RS pattern that occupies more than two consecutive OFDM symbols.) In this example, there are two CPs for this RS pattern, i.e., the first CP is before the RS signal and the second CP is after the RS signal. The RS signal is in between the two CPs.

Accordingly, a method in accordance with various embodiments may include a wireless device (e.g., an aggressor wireless device 108) transmitting, and another wireless device (e.g., a victim wireless device 110) receiving an RS pattern, wherein the RS pattern occupies two or more consecutive symbols, and wherein the RS pattern comprises a first CP, at least one RS signal, and a second CP. The at least one RS signal may be between the first CP and the second CP in the RS pattern.

In various approaches, assuming the length of RS in time domain is T_{RS}, and the length of the first CP and second CP in time domain are T_{CP1} and T_{CP2}, respectively, the sum of T_{RS}, T_{CP1}, and T_{CP2} is the same as the length of these two consecutive OFDM symbols in time domain. This new RS pattern design can also be applied to signal transmitted in one symbol. In this case, the sum of T_{RS}, T_{CP1}, and T_{CP2} is the same as the length of the OFDM symbol in time domain.

With reference to FIG. 6, in some examples, the signal in the first CP may be the same as the last T_{CP1} signal in the RS signal. Similarly, the signal in the second CP may be the same as the first T_{CP2} signal in the RS signal. In other words, the last TCP signal in the RS signal is copied to the first CP, and the first T_{CP2} signal in the RS signal is copied to the second CP.

As such, the method may include the wireless device (e.g., aggressor wireless device 108) transmitting, and the other wireless device (e.g., victim wireless device 110) receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal.

In accordance with various embodiments, T_{CP2} may be equal to T_{RS}. In this case, the signal in the second CP is the same as the RS signal itself.

With this new RS pattern design, no matter when the victim wireless device 110 starts receiving this RS signal, or when the victim wireless device 110 starts its FFT window, the victim wireless device 110 can obtain the whole RS signal and thus obtain accurate measurement results. Because, no matter when the victim wireless device 110 starts its FFT window, the victim wireless device 110 can obtain the same signal with or without rotation.

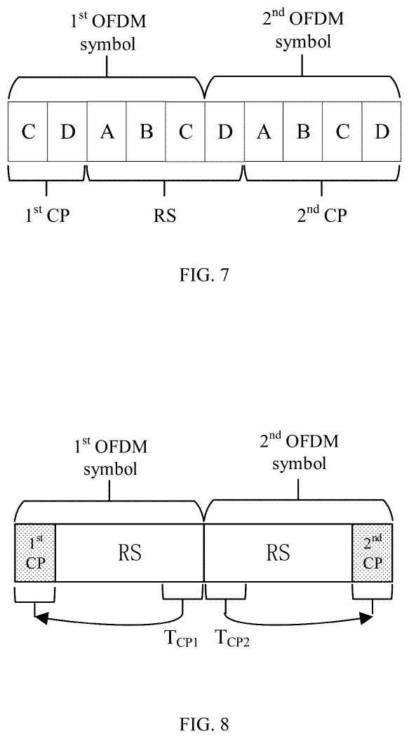

Referring to FIG. 7 as an example, the length of the first OFDM symbol and the second OFDM symbol is 5. The length of the RS signal is 4. The length of the first CP is 2, and the length of the second CP is 4. Assuming the signal transmitted as the RS signal is “ABCD,” then the first CP is “CD” and the second CP is “ABCD” in this example. If the victim wireless device 110 starts its FFT window at, for example, the fourth sample, and the window size is four, then the victim wireless device 110 will receive “BCDA” during the FFT window. After performing FFT operation, the victim wireless device 110 obtains the same information as “ABCD,” even through the information was received in a different order.

In order to minimize the interference between the RS signal and other signals transmitted in the first OFDM symbol and second OFDM symbol, some special setting can be applied. In one embodiment, the length of the first CP of the RS (T_{CP1}) is equal to the sum of the length of the CP for the signal transmitted in the first OFDM symbol and the length of the CP for the signal transmitted in the second OFDM symbol (e.g., when the RS patterns is the same length as two consecutive OFDM signals). The length of the RS signal (T_{RS}) is equal to the length of the signal transmitted in the first OFDM symbol and is equal to the length of signal transmitted in the second OFDM symbol.

In one example embodiment, the length of the RS signal is given by T_{RS}=2048k·2^{-u}, where k is equal to 64 and u is the OFDM numerology according to 3GPP TS38.211, an example of which is provided below. By setting these configurations, the interference between the RS occupying two consecutive OFDM symbols and the signal transmitted in the first OFDM symbol and second OFDM symbol can be minimized due to the characteristics of OFDM transmission. Put another way, it is equivalent to transmitting the RS with a smaller subcarrier spacing compared with the signal transmitted in the first OFDM symbol and second OFDM symbol.

| u | OFDM subcarrier spacing (kHz) |
|---|---|
| 0 | 15 |
| 1 | 30 |
| 2 | 60 |
| 3 | 120 |
| 4 | 240 |

Referring to FIG. 8 as an example, signal #1 and signal #2 are transmitted in the first OFDM symbol and the second OFDM symbol, respectively. Signal #1 and signal #2 have one CP before the start of signal #1 and signal #2, respectively. The length of the CP for signal #1 and signal #2 is T_{CPA} and T_{CPB}, respectively. Then, in various embodiments, T_{CP1}=T_{CPA}+T_{CPB}. Also, T_{RS} is the same length as the signal #1 and signal #2 transmitted in the first OFDM symbol and second OFDM symbol, respectively.

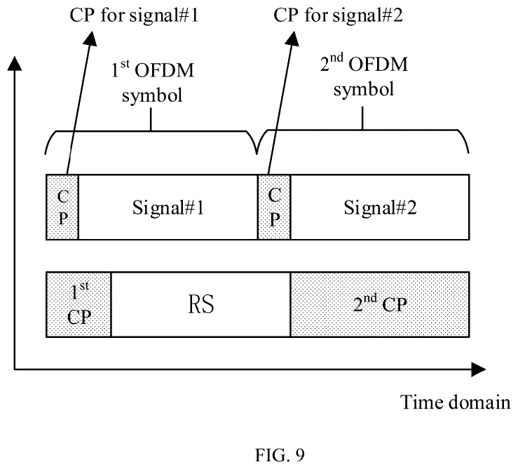

Referring to FIG. 9, a second alternative is illustrated. In accordance with various embodiments, the RS signal may be repeated for M times, where M is an integer number and M is larger than 1. As such, the method may include the wireless device (e.g., aggressor wireless device 108) transmitting, and the other wireless device (e.g., victim wireless device 110) receiving, as part of the RS pattern, the at least one RS signal M times, wherein M is an integer and M is larger than 1.

In some embodiments, in a similar manner as was discussed above with reference to FIGS. 6 and 7, the signal in the first CP may be the same as the last T_{CP1} signal in the RS signal, and the signal in the second CP may be the same as the first T_{CP2} signal in the RS signal. In other words, the last T_{CP1} signal in the RS signal may be copied to the first CP, and the first T_{CP2} signal in the RS signal may be copied to the second CP. FIG. 9 illustrates this embodiment in an example where M is equal to 2 (e.g., the RS signal is repeated for two times).

As such, the method may include the wireless device (e.g., aggressor wireless device 108) transmitting, and the other wireless device (e.g., victim wireless device 110) receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal.

In order to minimize the interference between the RS and other signal transmitted in the first OFDM symbol and the second OFDM symbol, some special settings can be applied. In one embodiment, the length of the first CP of the RS (T_{CP1}) is equal to the length of the CP for the signal transmitted in the first OFDM symbol. The length of the second CP of the RS (T_{CP2}) is equal to the length of the CP for the signal transmitted in the second OFDM symbol. The total length of the RS signal (M*T_{RS}) is equal to the sum of the length of the signal transmitted in the first OFDM symbol and the length of the signal transmitted in the second OFDM symbol. In case M is equal to 2, which means the RS signal is repeated twice, the length of each repetition of the RS signal (T_{RS}) is equal to the length of the signal transmitted in the first OFDM symbol, and is equal to the length of signal transmitted in the second OFDM symbol.

In one embodiment, for example, where M=2, the total length of the RS signal is given by M*T_{RS}=4096k·2^{-u}, where k is equal to 64 and u is the OFDM numerology according to 3GPP TS38.211. By setting these configurations, the interference between the RS occupies two consecutive OFDM symbols and the signal transmitted in the first OFDM symbol and second OFDM symbol can be minimized due to the characteristics of OFDM transmission. Put another way, it is equivalent to transmitting the RS with a smaller subcarrier spacing compared with the signal transmitted in the first OFDM symbol and the second OFDM symbol.

With this new RS pattern design, no matter when the victim wireless device 110 starts receiving this RS pattern, or when the victim wireless device 110 starts its FFT window, the victim wireless device 110 can obtain the whole RS signal and thus obtain accurate measurement results.

In a second overarching approach, the above described embodiments can also apply to RS patterns that occupy more than two consecutive OFDM symbols. In this second overarching approach, for one subcarrier spacing, one RS pattern occupies N consecutive OFDM symbols corresponding the subcarrier spacing, wherein N is an integer number and N is larger than 2. As with above, there may be two CPs for this RS pattern, wherein the first CP is before the RS signal and the second CP is after the RS signal, such that the at least one RS signal is between the first CP and the second CP in the RS pattern.

As with above, in some examples, assuming the length of the RS signal in time domain is T_{RS}, and the length of the first CP and the second CP in time domain are T_{CP1} and T_{CP2}, respectively, the sum of T_{RS}, T_{CP1}, and T_{CP2} is the same as the length of the N consecutive OFDM symbols in time domain. This new RS design can also be applied to signal transmitted in one symbol. In this case, the sum of T_{RS}, T_{CP1}, and T_{CP2} is the same as the length of the OFDM symbol in time domain.

Also as discussed above, in some examples, the signal in the first CP may be the same as the last T_{CP1} signal in the RS signal. Similarly, the signal in the second CP may be the same as the first T_{CP2} signal in the RS signal. In other words, the last T_{CP1} signal in the RS signal is copied to the first CP, and the first T_{CP2} signal in the RS signal is copied to the second CP.

As such, the method may include the wireless device (e.g., aggressor wireless device 108) transmitting, and the other wireless device (e.g., victim wireless device 110) receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal.

Also, again, in accordance with various embodiments, T_{CP2} may be equal to T_{RS}. In this case, the signal in the second CP is the same as the RS signal itself.

Also as discussed above, in a second alternative, the RS signal may be repeated for M times, where M is an integer number and M is larger than 1. As such, the method may include the wireless device (e.g., aggressor wireless device 108) transmitting, and the other wireless device (e.g., victim wireless device 110) receiving, as part of the RS pattern, the at least one RS signal M times, wherein M is an integer and M is larger than 1.

Also, in some embodiments, in a similar manner as was discussed above with reference to FIGS. 6, 7, and 9, the signal in the first CP may be the same as the last T_{CP1} signal in the RS signal, and the signal in the second CP may be the same as the first T_{CP2} signal in the RS signal. In other words, the last T_{CP1} signal in the RS signal may be copied to the first CP, and the first T_{CP2} signal in the RS signal may be copied to the second CP.

As such, the method may again include the wireless device (e.g., aggressor wireless device 108) transmitting, and the other wireless device (e.g., victim wireless device 110) receiving a first CP signal during the first CP, wherein the first CP signal is identical to a last T_{CP1} portion of the at least one RS signal, and a second CP signal during the second CP, wherein the second CP signal is identical to a first T_{CP2} portion of the at least one RS signal.

In another embodiment, in order to leave sufficient time for a wireless device (e.g., a UE or a base station) to perform DL-UL switching and leave sufficient time for the timing advance, usually 1 or 2 symbols are reserved as gap symbol. During the gap symbols, no DL transmission and no UL transmission are transmitted. However, a base station typically performs the DL-UL switching relatively fast, usually less than 13 us. Thus, a base station may be able to transmit or receive during the gap symbols, as long as sufficient time is reserved for DL-UL switching.

Because a UE's UL transmission and DL transmission are not scheduled during the gap symbols, to avoid or minimize the impact to UE scheduling, the RS pattern occupying, for example, two or more (e.g., N) consecutive OFDM symbols with the new design disclosed herein can be transmitted in the DL symbols overlapping with the gap symbols of the victim wireless device 110 or can be transmitted overlapping with the gap symbols of the aggressor wireless device 108. Alternatively, the RS pattern can be transmitted partially overlapping with either of these gap symbols. For example, the first OFDM symbol may be in the DL symbol and the second OFDM symbol may be in the gap symbol.

As such, the method may include the wireless device (e.g., aggressor wireless device 108) transmitting, and the other wireless device (e.g., victim wireless device 110) receiving the RS pattern in DL symbols at least partially overlapping with gap symbols of either the wireless device or another wireless device.

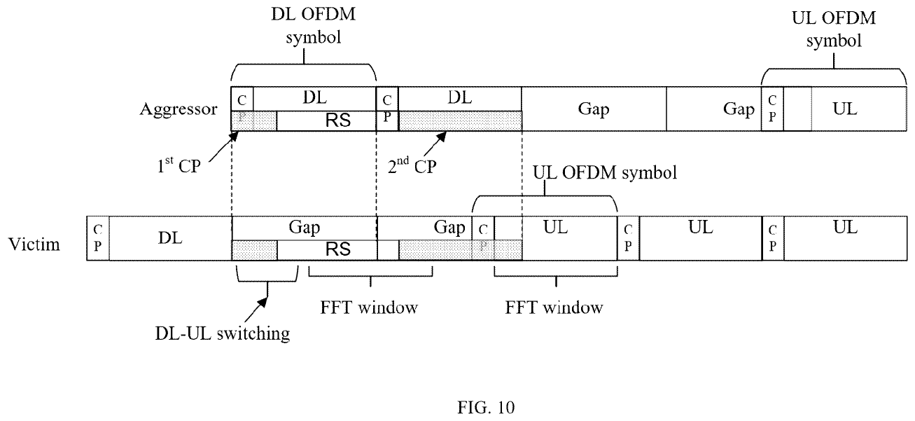

As shown in FIG. 10, the RS pattern is transmitted in the DL symbols that are overlapping with the gap symbols of the victim wireless device 110. Similarly, the RS pattern can be transmitted in the gap symbols of the aggressor wireless device 108. To further avoid CLI to the victim wireless device 110, the aggressor wireless device 108 doesn't need to transmit the entirety of the second CP of the RS pattern. In other words, the aggressor wireless device 108 may only transmit the first T₂ₜᵣₐₙₛ signal of the second CP, where 0≤T₂ₜᵣₐₙₛ≤T_{CP2}. As such, the method may include the wireless device (e.g., aggressor wireless device 108) transmitting, and the other wireless device (e.g., victim wireless device 110) receiving only a first portion of the second CP. Similarly, in embodiments that utilize M repeated RS signals, then the aggressor wireless device 108 may also only transmit part of the Mth (last) RS signal (e.g., it will end transmission before or at the same time as the CP of the UL of the victim wireless device 110 begins).

In certain embodiments, the gap symbols are flexible symbols configured by the base station or symbols indicated by the base station. In one embodiment, the victim wireless device 110 indicates the location of the gap symbols to the aggressor wireless device 108. The aggressor wireless device 108 determines the symbols that are overlapping with the gap symbols of victim wireless device 110, and transmits the RS pattern in these symbols.

As such, the method may include the wireless device (e.g., aggressor wireless device 108) receiving, and the other wireless device (e.g., victim wireless device 110) transmitting an indication of a location of the gap symbols. The wireless device (e.g., aggressor wireless device 108) may then perform determining symbols that are at least partially overlapping with the gap symbols. And the method may include the wireless device (e.g., aggressor wireless device 108) transmitting, and the other wireless device (e.g., victim wireless device 110) receiving the RS pattern in the symbols that are at least partially overlapping with the gap symbols.

In another embodiment, in order to implement the RS being repeated M times in the time domain, a comb-like design of the RS signal in the frequency domain can be applied. For example, if the signal in frequency domain is [1+0i, 2+0i, 3+0i, 4+0i], where i is the imaginary unit, the signal transformed into time domain is [10+0i, −2+2i, −2+0i, −2−2i] after performing FFT. If zeros are inserted into the signal in frequency domain as, for example, [1+0i, 0, 2+0i, 0, 3+0i, 0, 4+0i, 0], then the signal transformed into time domain is [10+0i, −2+2i, −2+0i, −2-2i, 10+0i, −2+2i, −2+0i, −2−2i]. The signal in time domain is repeated twice in comparison.

In accordance with this embodiment, the RS signal may be mapped to frequency resources every P REs (resource element), where P is an integer number and P is larger than 0. An offset S can be configured to indicate different REs for different reference signals. In certain embodiments, no signal is transmitted in the REs between every P REs for the RS. If the indexes of REs are numbered from 0, then the RS is mapped to REs with index Pn+S, where n is nonnegative integer number.

As such, the method may include the wireless device (e.g., aggressor wireless device 108) transmitting or mapping, and the other wireless device (e.g., victim wireless device 110) receiving the RS signal mapped to frequency resources every P resource elements (REs), wherein P is an integer larger than 0. The method may also include the wireless device (e.g., aggressor wireless device 108) transmitting, and the other wireless device (e.g., victim wireless device 110) receiving no signal in REs between the every P REs.

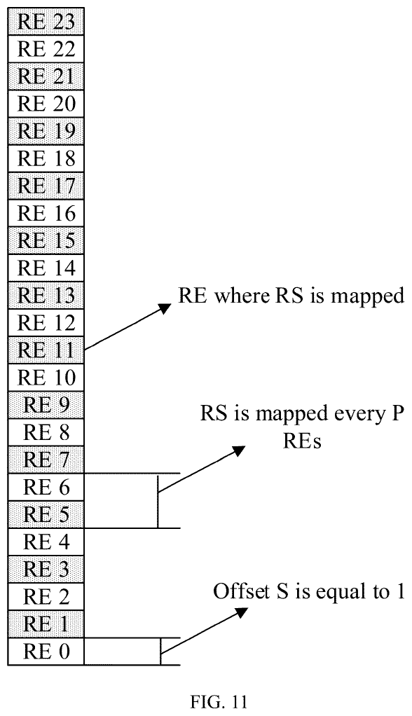

For example, with reference to FIG. 11, 24 REs are reserved for this RS signal in the frequency domain. If the REs from the lowest frequency to the highest frequency are indexed from 0 to 23, and P is equal to 2 and S is equal to 1, then the RS signal may be mapped to REs with index 1, 3, 5, 7, 9, 11, 13, 15, 17, 19, 21, 23, as is shown in FIG. 11.

In various approaches, the P may be determined (e.g., by the aggressor wireless device 108) by the subcarrier spacing of the aggressor wireless device 108 and the victim wireless device 110. If the numerology of subcarrier spacing for the aggressor wireless device 108 and the victim wireless device 110 is u_{A} and u_{V}, respectively, then P=2^{u}^{_{V}}^{-u}^{_{A}}, wherein u_{V} is not smaller than u_{A}.

Alternatively, in other approaches, the P may be determined (e.g., by the aggressor wireless device 108) by the subcarrier spacing of aggressor wireless device 108 and a reference subcarrier spacing. If the numerology of subcarrier spacing for the aggressor wireless device 108 and the reference subcarrier spacing is u_{A} and u_{R}, respectively, then P=2^{u}^{_{V}}^{-u}^{_{R}}, wherein u_{V} is not smaller than u_{R}. The reference subcarrier spacing may be configured by the base station or indicated by the victim wireless device 110.

In some approaches, S may be configured by the aggressor wireless device 108. As such, the method may include the wireless device (e.g., aggressor wireless device 108) configuring and/or indicating, and the other wireless device (e.g., victim wireless device 110) receiving, an offset S to indicate different REs for different reference signals to receive the RS pattern.

The aggressor wireless device 108 may configure or indicate to the victim wireless device 110 the corresponding subcarrier spacing to receive the RS pattern. As such, the method may include the wireless device (e.g., aggressor wireless device 108) configuring and/or indicating, and the other wireless device (e.g., victim wireless device 110) receiving, a subcarrier spacing for different reference signals to receive the RS pattern.

For example, if subcarrier spacing for the aggressor wireless device 108 and the victim wireless device 110 is 15 KHz, respectively, and the aggressor wireless device 108 configures the S as 2, then the aggressor wireless device 108 indicates the victim wireless device 110 to receive the RS pattern with subcarrier spacing 30 KHz. Because the RS will be repeated twice and the victim wireless device 110 only needs to measure it once.

In another embodiment, as shown in FIG. 4, a main issue that needs to be addressed is the timing misalignment between the aggressor wireless device 108 and the victim wireless device 110. One straightforward solution is to adjust the aggressor wireless device's 108 transmission starting time within the symbol. The RS is transmitted T_{adjust} in advance or later from the start of the symbol such that the transmitted RS is aligned with the UL slot duration of victim wireless device 110. T_{adjust} is in time units T_{c}=1/(Δfₘₐₓ·N_{f}), where Δfₘₐₓ=480·10³ Hz, and N_{f}=4096. T_{adjust} is an integer number. The T_{adjust} can be indicated by the victim wireless device 110. Typically, in order to accommodate the timing misalignment between the aggressor wireless device 108 and the victim wireless device 110, the absolute value of T_{adjust} may not be smaller than 25600.

Alternatively, the victim wireless device 110 may adjust its receiving timing by T_{adjust} in advance or later from the start of the symbol such that the victim wireless device 110 can receive the RS within the FFT window. T_{adjust} is in time units T_{c}=1/(Δfₘₐₓ·N_{f}) where Δfₘₐₓ=480·10³ Hz, and N_{f}=4096. T_{adjust} is an integer number. The T_{adjust} can be indicated by the aggressor wireless device 108.

Although the above description only discusses the new reference signal pattern mechanism with respect to reference signals (RS), the new patterns are not so limited in their application and can also be used for data channels, e.g., DL data channel and UL data channel.

Although the above description only discusses the new reference signal pattern mechanism with respect to OFDM symbol, the new patterns are not so limited in their application and can also be used for other symbols, e.g., CDM (Code Division Multiplexing) symbols.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method performed by wireless device comprising:
transmitting a Reference Signal (RS) pattern, wherein the RS pattern occupies two or more consecutive symbols, and wherein the RS pattern comprises:
a first cyclic prefix (CP);
at least one RS signal; and
a second CP.

2. The method according to claim 1, wherein the at least one RS signal is between the first CP and the second CP in the RS pattern.

3. The method according to claim 1, wherein a length of the RS signal in time domain is T_{RS}, a length of the first CP in the time domain is T_{CP1}, a length of the second CP in the time domain is T_{CP2}, and wherein a sum of T_{RS}, T_{CP1}, and T_{CP2} is equal to a length of the two or more consecutive symbols in the time domain.

4. The method according to claim 1, wherein a length of the RS signal in time domain is T_{RS}, wherein a length of the first CP in the time domain is T_{CP1}, a length of the second CP in the time domain is T_{CP2}, the method further comprising:
transmitting a first CP signal during the first CP, wherein the first CP signal is identical to a last T_{CP1} portion of the at least one RS signal; and
transmitting a second CP signal during the second CP, wherein the second CP signal is identical to a first T_{CP2} portion of the at least one RS signal.

5. The method according to claim 4, wherein T_{RS} is equal to T_{CP2}.

6. The method according to claim 4, wherein the second CP signal is identical to one RS signal.

7. The method according to claim 1, wherein the RS pattern occupies two consecutive symbols, wherein a length of the RS signal in time domain is T_{RS}, a length of the first CP in the time domain is T_{CP1}, a length of the second CP in the time domain is T_{CP2}, and
wherein T_{CP1} is equal to a sum of a length of a CP for a signal transmitted in a first symbol of the two consecutive symbols and a length of a CP for a signal transmitted in a second symbol of the two consecutive symbols, and
wherein T_{RS} is equal to a length of the signal transmitted in the first symbol and is equal to a length of the signal transmitted in the second symbol.

8. The method according to claim 1, further comprising:
transmitting, as part of the RS pattern, the at least one RS signal M times, wherein M is an integer and M is larger than 1.

9. The method according to claim 8, wherein a length of the RS signal in time domain is T_{RS}, wherein a length of the first CP in the time domain is T_{CP1}, a length of the second CP in the time domain is T_{CP2}, the method further comprising:
transmitting a first CP signal during the first CP, wherein the first CP signal is identical to a last T_{CP1} portion of the at least one RS signal; and
transmitting a second CP signal during the second CP, wherein the second CP signal is identical to a first T_{CP2} portion of the at least one RS signal.

10. The method according to claim 8, wherein a length of the RS signal in time domain is T_{RS}, wherein a length of the first CP in the time domain is T_{CP1}, a length of the second CP in the time domain is T_{CP2},
wherein T_{CP1} is equal to a length of a CP for a signal transmitted in the first symbol of the two or more consecutive symbols,
wherein T_{CP2} is equal to a length of a CP for a signal transmitted in the second symbol of the two or more consecutive symbols, and
wherein M*T_{RS} is equal to a sum of a length of the signal transmitted in the first symbol and a length of the signal transmitted in the second symbol.

11. The method according to claim 10, wherein M=2, and
wherein T_{RS} is equal to the length of the signal transmitted in the first symbol and is equal to the length of the signal transmitted in the second symbol.

12. The method according to claim 1, wherein the RS pattern occupies N consecutive symbols, wherein N is an integer larger than 2.

13. The method according to claim 12, wherein the at least one RS signal is between the first CP and the second CP in the RS pattern.

14. The method according to claim 12, wherein a length of the RS signal in time domain is T_{RS}, a length of the first CP in the time domain is T_{CP1}, a length of the second CP in the time domain is T_{CP2}, and wherein a sum of T_{RS}, T_{CP1}, and T_{CP2} is equal to a length of the N consecutive symbols in the time domain.

15. The method according to claim 12, wherein a length of the RS signal in time domain is T_{RS}, wherein a length of the first CP in the time domain is T_{CP1}, a length of the second CP in the time domain is T_{CP2}, the method further comprising:
transmitting a first CP signal during the first CP, wherein the first CP signal is identical to a last T_{CP1} portion of the at least one RS signal; and
transmitting a second CP signal during the second CP, wherein the second CP signal is identical to a first T_{CP2} portion of the at least one RS signal.

16. The method according to claim 15, wherein T_{RS} is equal to T_{CP2}.

17. The method according to claim 15, wherein the second CP signal is identical to one RS signal.

18. The method according to claim 12, further comprising:
transmitting, as part of the RS pattern, the at least one RS signal M times, wherein M is an integer and M is larger than 1.

19. The method according to claim 18, wherein a length of the RS signal in time domain is T_{RS}, wherein a length of the first CP in the time domain is T_{CP1}, a length of the second CP in the time domain is T_{CP2}, the method further comprising:
transmitting a first CP signal during the first CP, wherein the first CP signal is identical to a last T_{CP1} portion of the at least one RS signal; and
transmitting a second CP signal during the second CP, wherein the second CP signal is identical to a first T_{CP2} portion of the at least one RS signal.

20. The method according to claim 1, further comprising:
transmitting the RS pattern in downlink (DL) symbols at least partially overlapping with gap symbols of either the wireless device or another wireless device.

21. The method according to claim 20, further comprising
transmitting only a first portion of the second CP.

22. The method according to claim 20, wherein the gap symbols are configured or indicated by a base station, and the method further comprising:
receiving, by the wireless device from another wireless device, an indication of a location of the gap symbols; and
determining symbols that are at least partially overlapping with the gap symbols; and
transmitting the RS pattern in the symbols that are at least partially overlapping with the gap symbols.

23. The method according to claim 1, further comprising:
mapping the RS signal to frequency resources every P resource elements (REs), wherein P is an integer larger than 0.

24. The method according to claim 23, further comprising:
transmitting no signal in REs between the every P REs.

25. The method according to claim 23, further comprising:
configuring, by the wireless device, an offset S to indicate different REs for different reference signals.

26. The method according to claim 23, further comprising:
indicating, by the wireless device to another wireless device, a subcarrier spacing to receive the RS pattern.

27. The method according to claim 23, further comprising:
determining a value of P based on subcarrier spacing,
wherein a numerology of subcarrier spacing for the wireless device and another wireless device is u_{A} and u_{V}, respectively,
wherein u_{V} is not smaller than u_{A}, and
$$wherein P = {2}^{{u}_{V} - {u}_{A}} .$$

28. The method according to claim 23, further comprising:
determining a value of P based on subcarrier spacing of the wireless device and a reference subcarrier spacing,
wherein a numerology of subcarrier spacing for the wireless device and the reference subcarrier spacing is u_{A} and u_{R}, respectively,
wherein u_{V} is not smaller than u_{R}, and
$$wherein P = {2}^{{u}_{V} - {u}_{R}} .$$

29. A method performed by wireless device comprising:
receiving a Reference Signal (RS) pattern, wherein the RS pattern occupies two or more consecutive symbols, and wherein the RS pattern comprises:
a first cyclic prefix (CP);
at least one RS signal; and
a second CP.

30. The method according to claim 29, wherein the at least one RS signal is between the first CP and the second CP in the RS pattern.

31. The method according to claim 29, wherein a length of the RS signal in time domain is T_{RS}, a length of the first CP in the time domain is T_{CP1}, a length of the second CP in the time domain is T_{CP2}, and wherein a sum of T_{RS}, T_{CP1}, and T_{CP2} is equal to a length of the two or more consecutive symbols in the time domain.

32. The method according to claim 29, wherein a length of the RS signal in time domain is T_{RS}, wherein a length of the first CP in the time domain is T_{CP1}, a length of the second CP in the time domain is T_{CP2}, the method further comprising:
receiving a first CP signal during the first CP, wherein the first CP signal is identical to a last T_{CP1} portion of the at least one RS signal; and
receiving a second CP signal during the second CP, wherein the second CP signal is identical to a first T_{CP2} portion of the at least one RS signal.

33. The method according to claim 32, wherein T_{RS} is equal to T_{CP2}.

34. The method according to claim 32, wherein the second CP signal is identical to one RS signal.

35. The method according to claim 29, wherein the RS pattern occupies two consecutive symbols, wherein a length of the RS signal in time domain is T_{RS}, a length of the first CP in the time domain is T_{CP1}, a length of the second CP in the time domain is T_{CP2}, and
wherein T_{CP1} is equal to a sum of a length of a CP for a signal transmitted in a first symbol of the two consecutive symbols and a length of a CP for a signal transmitted in a second symbol of the two consecutive symbols, and
wherein T_{RS} is equal to a length of the signal transmitted in the first symbol and is equal to a length of the signal transmitted in the second symbol.

36. The method according to claim 29, further comprising:
receiving, as part of the RS pattern, the at least one RS signal M times, wherein M is an integer and M is larger than 1.

37. The method according to claim 36, wherein a length of the RS signal in time domain is T_{RS}, wherein a length of the first CP in the time domain is T_{CP1}, a length of the second CP in the time domain is T_{CP2}, the method further comprising:
receiving a first CP signal during the first CP, wherein the first CP signal is identical to a last T_{CP1} portion of the at least one RS signal; and
receiving a second CP signal during the second CP, wherein the second CP signal is identical to a first T_{CP2} portion of the at least one RS signal.

38. The method according to claim 36, wherein a length of the RS signal in time domain is T_{RS}, wherein a length of the first CP in the time domain is T_{CP1}, a length of the second CP in the time domain is T_{CP2},
wherein T_{CP1} is equal to a length of a CP for a signal transmitted in the first symbol of the two or more consecutive symbols,
wherein T_{CP2} is equal to a length of a CP for a signal transmitted in the second symbol of the two or more consecutive symbols, and
wherein M*T_{RS} is equal to a sum of a length of the signal transmitted in the first symbol and a length of the signal transmitted in the second symbol.

39. The method according to claim 38, wherein M=2, and
wherein T_{RS} is equal to the length of the signal transmitted in the first symbol and is equal to the length of the signal transmitted in the second symbol.

40. The method according to claim 29, wherein the RS pattern occupies N consecutive symbols, wherein N is an integer larger than 2.

41. The method according to claim 40, wherein the at least one RS signal is between the first CP and the second CP in the RS pattern.

42. The method according to claim 40, wherein a length of the RS signal in time domain is T_{RS}, a length of the first CP in the time domain is T_{CP1}, a length of the second CP in the time domain is T_{CP2}, and wherein a sum of T_{RS}, T_{CP1}, and T_{CP2} is equal to a length of the N consecutive symbols in the time domain.

43. The method according to claim 40, wherein a length of the RS signal in time domain is T_{RS}, wherein a length of the first CP in the time domain is T_{CP1}, a length of the second CP in the time domain is T_{CP2}, the method further comprising:
receiving a first CP signal during the first CP, wherein the first CP signal is identical to a last T_{CP1} portion of the at least one RS signal; and
receiving a second CP signal during the second CP, wherein the second CP signal is identical to a first T_{CP2} portion of the at least one RS signal.

44. The method according to claim 43, wherein T_{RS} is equal to T_{CP2}.

45. The method according to claim 43, wherein the second CP signal is identical to one RS signal.

46. The method according to claim 40, further comprising:
receiving, as part of the RS pattern, the at least one RS signal M times, wherein M is an integer and M is larger than 1.

47. The method according to claim 46, wherein a length of the RS signal in time domain is T_{RS}, wherein a length of the first CP in the time domain is T_{CP1}, a length of the second CP in the time domain is T_{CP2}, the method further comprising:
receiving a first CP signal during the first CP, wherein the first CP signal is identical to a last T_{CP1} portion of the at least one RS signal; and
receiving a second CP signal during the second CP, wherein the second CP signal is identical to a first T_{CP2} portion of the at least one RS signal.

48. The method according to claim 29, further comprising:
receiving the RS pattern in downlink (DL) symbols at least partially overlapping with gap symbols of either the wireless device or another wireless device.

49. The method according to claim 48, further comprising
receiving only a first portion of the second CP.

50. The method according to claim 48, wherein the gap symbols are configured or indicated by a base station, and the method further comprising:
transmitting, by the wireless device to another wireless device, an indication of a location of the gap symbols; and
receiving the RS pattern in symbols that are at least partially overlapping with the gap symbols.

51. The method according to claim 29, further comprising:
receiving the RS signal mapped to frequency resources every P resource elements (REs), wherein P is an integer larger than 0.

52. The method according to claim 51, further comprising:
receiving no signal in REs between the every P REs.

53. The method according to claim 51, further comprising:
receiving a configuration from another wireless device of an offset S to indicate different REs for different reference signals.

54. The method according to claim 51, further comprising:
receiving an indication, by the wireless device from another wireless device, of a subcarrier spacing to receive the RS pattern.

55. The method according to claim 51,
wherein a numerology of subcarrier spacing for the wireless device and another wireless device is u_{V} and u_{A}, respectively,
wherein u_{V} is not smaller than u_{A}, and
$$wherein P = {2}^{{u}_{V} - {u}_{A}} .$$

56. The method according to claim 51,
wherein a numerology of subcarrier spacing for another wireless device and a reference subcarrier spacing is u_{A} and u_{R}, respectively,
wherein u_{V} is not smaller than u_{R}, and
$$wherein P = {2}^{{u}_{V} - {u}_{R}} .$$

57. An apparatus for wireless communication comprising a processor that is configured to carry out the method of any of claims 1 to 56.

58. A non-transitory computer readable medium having code stored thereon, the code when executed by a processor, causing the processor to implement the method recited in any of claims 1 to 56.
